(19) United States
(12) Patent Application Publication
(10) Pub. No.: US 2011/0314337 A1
(43) Pub. Date: Dec. 22, 2011

(54) Method and Apparatus for Locating Input-Model Faults Using Dynamic Tainting

(75) Inventors: Saurabh Sinha, New Delhi (IN); Pankaj Dhoolia, Uttar Pradesh (IN); Senthil Kk Mani, Haryana (IN); Vibha S. Sinha, New Delhi (IN)

(73) Assignee: INTERNATIONAL BUSINESS MACHINES CORPORATION, Armonk, NY (US)

(21) Appl. No.: 12/818,439

(22) Filed: Jun. 18, 2010

(51) Int. Cl. G06F 11/07

(52) U.S. Cl. 714/37; 714/49; 714/E11.024; 714/E11.029

(57) ABSTRACT

Approaches based on dynamic tainting to assist transform users in debugging input models. The approach instruments the transform code to associate taint marks with the input-model elements, and propagate the marks to the output text. The taint marks identify the input-model elements that either contribute to an output string, or cause potentially incorrect paths to be executed through the transform, which results in an incorrect or a missing string in the output. This approach can significantly reduce the fault search space and, in many cases, precisely identify the input-model faults. By way of a significant advantage, the approach automates, with a high degree of accuracy, a debugging task that can be tedious to perform manually.

### BACKGROUND

Model-to-text (M2T) transforms are a class of software applications that translate a structured input into text output. The input models to such transforms are complex, and faults in the models that cause an M2T transform to generate an incorrect or incomplete output can be hard to debug.

### BRIEF SUMMARY

Presented herein, in accordance with embodiments of the invention, is an approach based on dynamic tainting to assist transform users in debugging input models. The approach instruments the transform code to associate taint marks with the input-model elements, and propagate the marks to the output text. The taint marks identify the input-model elements that either contribute to an output string, or cause potentially incorrect paths to be executed through the transform, which results in an incorrect or a missing string in the output. This approach can significantly reduce the fault search space and, in many cases, precisely identify the input-model faults. By way of a significant advantage, the approach automates, with a high degree of accuracy, a debugging task that can be tedious to perform manually.

In summary, one aspect of the invention provides a method comprising: assimilating and instrumenting an input model; instrumenting a model to text transform; applying the instrumented transform to the instrumented input model; producing an output from the instrumented transform; and locating a fault in the input model based on an error location specified in the output.

Another aspect of the invention provides an apparatus comprising: one or more processors; and a computer readable storage medium having computer readable program code embodied therewith and executable by the one or more processors, the computer readable program code comprising: computer readable program code configured to assimilate and instrument an input model; computer readable program code configured to instrument a model to text transform; computer readable program code configured to apply the instrumented transform to the instrumented input model; computer readable program code configured to produce an output from the instrumented transform; and computer readable program code configured to locate a fault in the input model based on an error location specified in the output.

An additional aspect of the invention provides a computer program product comprising: a computer readable storage medium having computer readable program code embodied therewith, the computer readable program code comprising: computer readable program code configured to assimilate and instrument an input model; computer readable program code configured to instrument a model to text transform; computer readable program code configured to apply the instrumented transform to the instrumented input model; computer readable program code configured to produce an output from the instrumented transform; and computer readable program code configured to locate a fault in the input model based on an error location specified in the output.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 conveys an example of an input-model fault that causes an incorrect output.

FIG. 3 schematically illustrates input model faults, fault propagation through the transform, and resulting failures.

FIG. 4a conveys an XSL transform that generates name-value pairs.

FIG. 4b conveys pseudo-code corresponding to the transform of FIG. 4a.

FIG. 4c schematically conveys three faulty input models and incorrect outputs.

FIG. 5 schematically illustrates an approach in accordance with embodiments of the invention.

FIG. 6 conveys taint associations with the three faulty input models and output texts of the example from FIG. 4c.

FIG. 7a schematically illustrates a CFG of the sample transform of FIG. 4a.

FIG. 7b schematically illustrates a nonstructured if statement.

FIG. 7c schematically illustrates a loop with break statement.

FIG. 8. schematically illustrates architecture of an implementation for XSL-based transforms.

FIG. 9. conveys sample code fragments to illustrate program instrumentation performed in step 822 of FIG. 8.

FIG. 10 sets forth a process more generally for ascertaining faults in an output model based on taint marks associated with an input model

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

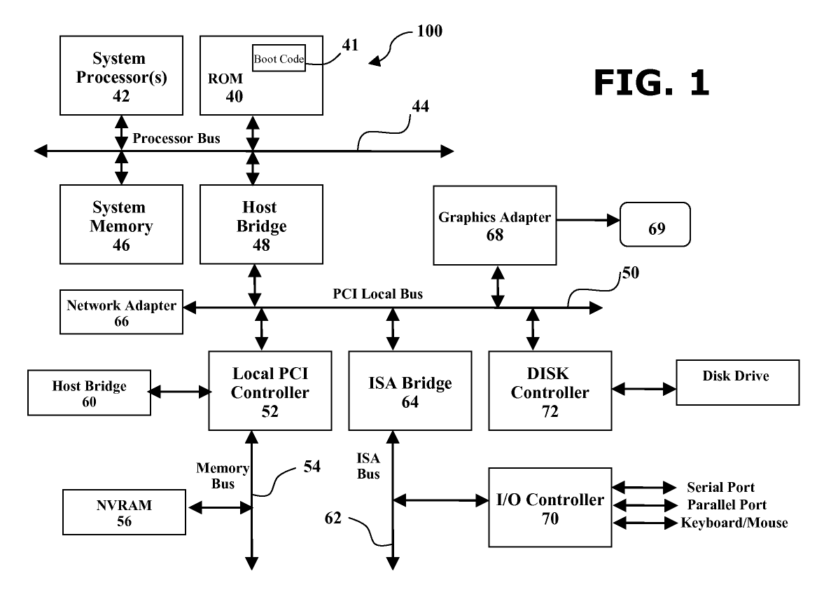

Referring now to FIG. 1, there is depicted a block diagram of an illustrative embodiment of a computer system 100. The illustrative embodiment depicted in FIG. 1 may be an electronic device such as a laptop or desktop personal computer, a mobile/smart phone or the like. As is apparent from the description, however, the embodiments of the invention may be implemented in any appropriately configured device, as described herein.

As shown in FIG. 1, computer system 100 includes at least one system processor 42, which is coupled to a Read-Only Memory (ROM) 40 and a system memory 46 by a processor bus 44. System processor 42, which may comprise one of the AMD line of processors produced by AMD Corporation or a processor produced by INTEL Corporation, is a general-purpose processor that executes boot code 41 stored within ROM 40 at power-on and thereafter processes data under the control of an operating system and application software stored in system memory 46. System processor 42 is coupled via processor bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN, and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a as a keyboard, mouse, serial and parallel ports, et cetera. A disk controller 72 connects a disk drive with PCI local bus 50. The USB Bus and USB Controller (not shown) are part of the Local PCI controller (52).

Model-Driven Engineering (MDE) (as discussed, for example, in Schmidt, D. C.: “Model-driven engineering,” IEEE Computer 39[2], 25-31 [2006]) represents a paradigm of software development that uses formal models, at different abstraction levels, to represent a system under development, and uses automated transforms to convert one model to another model or to text. (For the purposes of discussion herein, in accordance with embodiments of the invention, a transform may be considered to be a function, or a program, that maps one model to another model or text. A transformation, on the other hand, may be considered to be the application, or the execution, of a transform on a model instance.)

A model is typically represented using a structured format (e.g., XML [Extensible Markup Language] or UML [Unified Modeling Language]). A significant class of model transforms, called model-to-text (M2T) transforms, generate text output (e.g., code, configuration files, or HTML [Hypertext Markup Language]/JSP [JavaServer Pages] files) from an input model. The input models to the transforms are often large and complex. Therefore, the models can contain faults, such as a missing element or an incorrect value of an attribute, that cause a transformation to fail; in such cases, the transformation either generates no output (i.e., it terminates with an exception) or generates an incorrect output.

The structure of a model is defined by a metamodel. In many cases, a metamodel also specifies the semantic constraints that a model must satisfy. For example, to be a valid instance, a UML model may have to satisfy OCL (Object Constraint Language) constraints. A model can contain faults that violate such syntactic and semantic well-formedness properties. Such faults can be detected easily using automated validators that check whether a model conforms to the metamodel constraints.

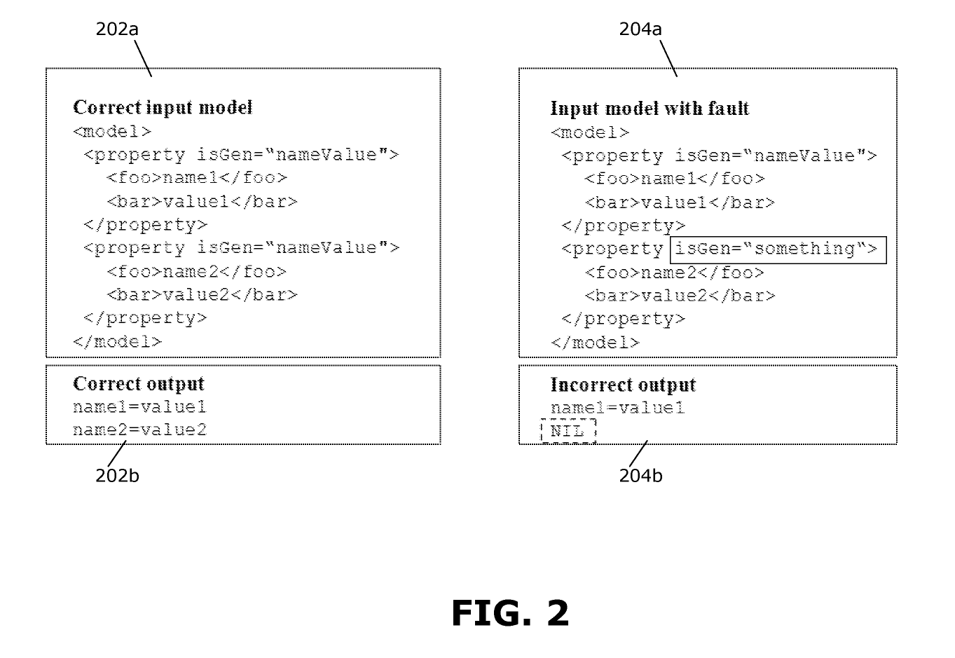

However, a large class of faults may violate no constraints and yet cause a transformation to fail; such faults cannot be detected using model validators. To illustrate, consider the model and output fragments shown in FIG. 2. Indicated at 202a is a correct input model to a transform that generates an output 202b as a configuration file that includes of name-value pairs. The input model 204a, on the other hand, contains a fault, in that the isGen attribute of the second property has an incorrect value. This fault causes a wrong transform path to be executed and, consequently, the incorrect substring “NIL” to be generated in the corresponding output 204b. However, the value of isGen is not constrained to be “nameValue” and a different value is, in fact, valid in cases where the user expects “NIL” to be generated. Thus, the interpretation of whether the isGen value represents a fault depends on what the user expects in the output. In this case, the value is a fault, but no automated validator can detect it. In a large and complex model, which could well include thousands of elements and attributes, locating such subtle faults can be difficult and time-consuming.

Although a transformation failure can be caused by faults in the transform, embodiments of the invention as broadly contemplated herein involve techniques for investigating failures caused by input-model faults. In MDE, it is a common practice for transform users to use transforms that are not written by them (e.g., many tools provide standard built-in transforms). Thus, a user's knowledge of the transform is limited to the information available from documentation and example models. Even if the code is available, the end-users often lack the technical expertise to debug the problem by examining the code. Thus, when a transformation fails, the pertinent task for transform users is to understand the input space, how it maps to the output, and identify faults in the input; investigating the transform code is irrelevant, and, in the absence of access to the transform implementation, impossible.

Generally, conventional arrangements for fault localization focus on identifying faults in the program. Generally, such arrangements act to narrow down the search space of program statements that considered to warrant examination for locating the fault. Among the involved techniques are program slicing or spectra comparisons for passing and failing executions. However, these conventional approaches are not applicable to localizing input-model faults.

Some researchers have investigated ways to extend the statement-centric view of debugging to consider also the subset of the input that is relevant for investigating a failure. For example, given an input i that causes a failure, delta debugging (see, for example, Zeller, A., Hildebrandt, R., “Simplifying and isolating failure-inducing input,” IEEE Trans. Software Eng. 28[2], 183-200 [2002]) identifies the minimal subset of i that would also cause the failure. Similarly, the known penumbra tool (see, for example, Clause, J., Orso, A.: “Penumbra: Automatically identifying failure-relevant inputs using dynamic tainting,” Proc. of the Intl. Symp. on Softw. Testing and Analysis, pp. 249-259[2009]) identifies the subset of i that is relevant for investigating the failure. These approaches could conceivably be used for debugging input models because the failure-relevant subset of the input model is likely to contain the fault. However, because these techniques are not targeted toward detecting input-model faults, in practice, they may perform poorly when applied to model debugging.

Model-tracing techniques create links between input-model and output-model entities, which can be useful for supporting fault localization in cases where an incorrect value of an input-model entity flows to the output through value propagation. However, for faults such as the one illustrated in FIG. 2, tracing techniques can provide no assistance in localizing the faults. Similarly, if the fault is a missing entity in the input or the manifested failure is a missing substring in the output, tracing techniques cannot assist with fault localization.

Broadly contemplated herein, in accordance with embodiments of the invention, is an approach for assisting transform users in locating faults in input models that cause a model-to-text transformation to fail. The invention, in at least one embodiment, serves to narrow down the fault search space in a failure-inducing input model.

In embodiments of the invention, dynamic tainting (see, for example, Clause, J., Li, W., Orso, A.: “Dytan: A generic dynamic taint analysis framework,” Proc. of the Intl. Symp. on Softw. Testing and Analysis, pp. 196-206[2007]) or information-flow analysis (see, for example, Masri, W., Podgurski, A., Leon, D., “Detecting and debugging insecure information flows,” Proc. of the Intl. Symp. on Softw. Reliability Eng, pp. 198-209[2004]) is employed to track the flow of data from input-model entities to the output string of a model-to-text transform. Particularly, given the input model I for a failing execution of a transform program P, an approach in accordance with the invention instruments (or designates) P to associate taint marks with the elements of I and propagate the marks to the output string. The execution of the instrumented (transform) program P generates a taint log, in which substrings of the output string have taint marks associated with them. The taint marks associated with a substring indicate the elements of I that influenced the generation of the substring. To locate the faults in I, the user first identifies the point in the output string at which a substring is missing or an incorrect substring is generated. Next, using the taint marks, the user can navigate back to entities of I, which constitute the search space for the fault.

In accordance with embodiments of the invention, in addition to identifying input-model entities from which data flows to the output, the taint marks also identify the entities that determine whether an alternative substring could have been generated at a particular point in the output string, had the failing execution traversed a different path through the transform. Such taint marks can be referred to as “control-taint marks”, as distinguished from “data-taint marks” as described hereabove. Unlike data-taint marks, which are propagated at assignment statements and statements that construct the output string, a control-taint mark is propagated to the output string at conditional statements. The propagation of control taints lets the approach identify faults that cause an incorrect path to be taken through the transform and, as a result, a missing or an incorrect substring in the output.

Also contemplated herein in accordance with embodiments of the invention are “loop-taint marks,” which, intuitively, scope out the execution of a loop. These taints help in locating faults that cause an incorrect number of loop iterations.

By way of a significant advantage, an approach (in accordance with embodiments of the invention automates, with a high degree of accuracy, a debugging task that can be tedious and time-consuming to perform manually. Such an approach is especially useful for localizing faults that cause an incorrect path to be executed or an incorrect number of iterations of a loop. Although such an approach is broadly presented herein at least in the context of model-to-text transforms, it is applicable more generally in cases where programs take large structured inputs and generate structured output, and where the goal of investigating a failure is to locate faults in the inputs.

Accordingly, there is broadly contemplated herein, in accordance with embodiments of the invention, a novel dynamic-tainting-based approach for localizing input-model faults that cause model-transformation failures. Also described herein is an implementation of the approach for XSL (Extensible Stylesheet Language)-based model-to-text transforms.

Generally speaking, model-to-text transforms are a special class of software applications that transform a complex input model into text-based files. Examples of such transforms include UML-to-Java code generators and XML-to-HTML format converters. A model-to-text transform can be coded using a general-purpose programming language, such as Java. Such a transform reads content from input files, performs the transformation logic, and writes the output to a file as a text string. Alternatively, a transform can be implemented using specialized templating languages, such as XSLT (Extensible Stylesheet Language Transformation) and JET (Java Emitter Templates) (see, for example, http://wiki.eclipse.org/M2T-JET), that let developers code the transform logic in the form of a template. The associated frameworks—Xalan (see, for example, http://xml.apache.org/xalan-j) for XSLT and the Eclipse Modeling Framework (EMF) (see, for example, http://www.eclipse.org/modeling/emf) for JET—provide the functionality to read the input into a structured format and write the output to a text file.

In accordance with embodiments of the invention, for purposes of discussion and illustration herein, a model is a collection of elements (that have attributes) and relations between the elements. (The term “entity”, as employed herein, can refer to either an element or an attribute.) A model is based on a well-defined notation that governs the schema and the syntax of how the model is represented as a physical file, and how the file can be read in a structured way. XML and UML are examples of commonly used notations to define a model.

The disclosure now turns to FIGS. 2-9. It should be appreciated that the processes, arrangements and products broadly illustrated therein can be carried out on or in accordance with essentially any suitable computer system or set of computer systems, which may, by way of an illustrative and non-restrictive example, include a system such as that indicated at 100 in FIG. 1. In accordance with an example embodiment, most if not all of the process steps, components and outputs discussed with respect to FIGS. 2-9 can be performed or utilized by way of system processors and system memory such as those indicated, respectively, at 42 and 46 in FIG. 1.

FIG. 2 shows an example of a model defined using XML. The model contains instances of property elements. Each property has an attribute isGen and contains elements foo and bar.

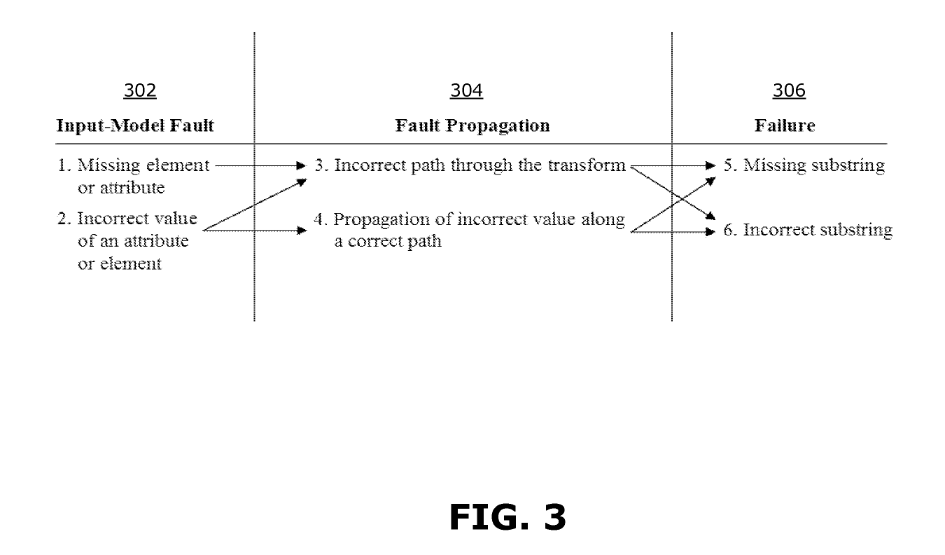

FIG. 3, on the other hand, presents an intuitive illustration of the propagation of input-model faults (302) through a transform (fault propagation 304), and the manifested failures (306). As shown, a fault can be a missing entity (1) or an incorrect value of an entity (2). A missing entity can cause a wrong path to be traversed through the transform (3). An incorrect entity value, on the other hand, can cause either a wrong path (3) or the propagation of the incorrect value along a correct path (4). An incorrect path through the transform manifests as either a missing substring (5) or an incorrect substring in the output (6). Similarly, the propagation of an incorrect value through the transform results in an incorrect string (5) or a missing string (6) (the latter, particularly, in cases where the incorrect value is an empty string).

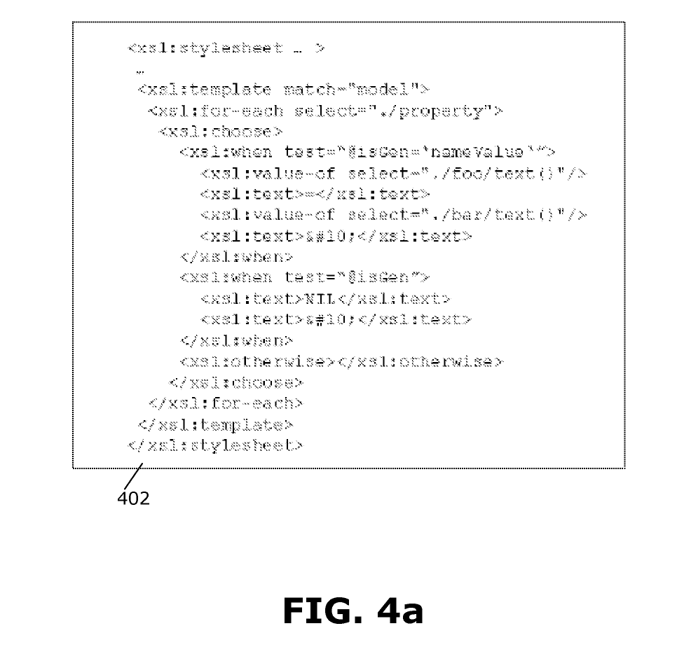

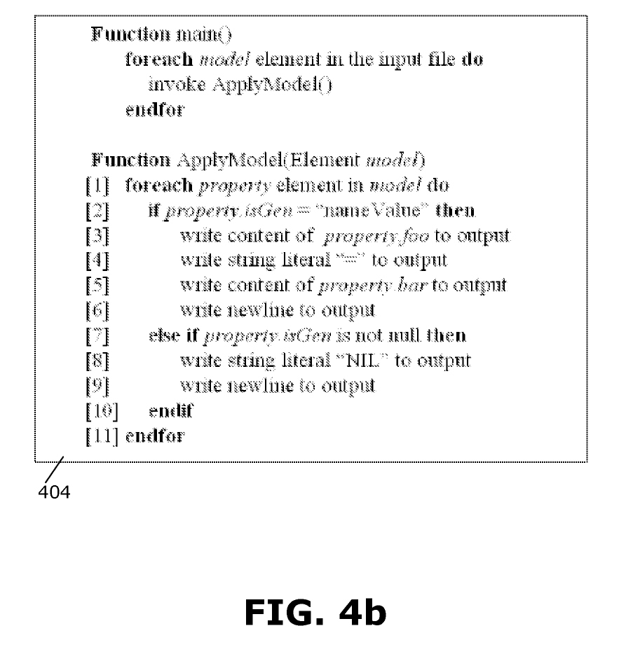

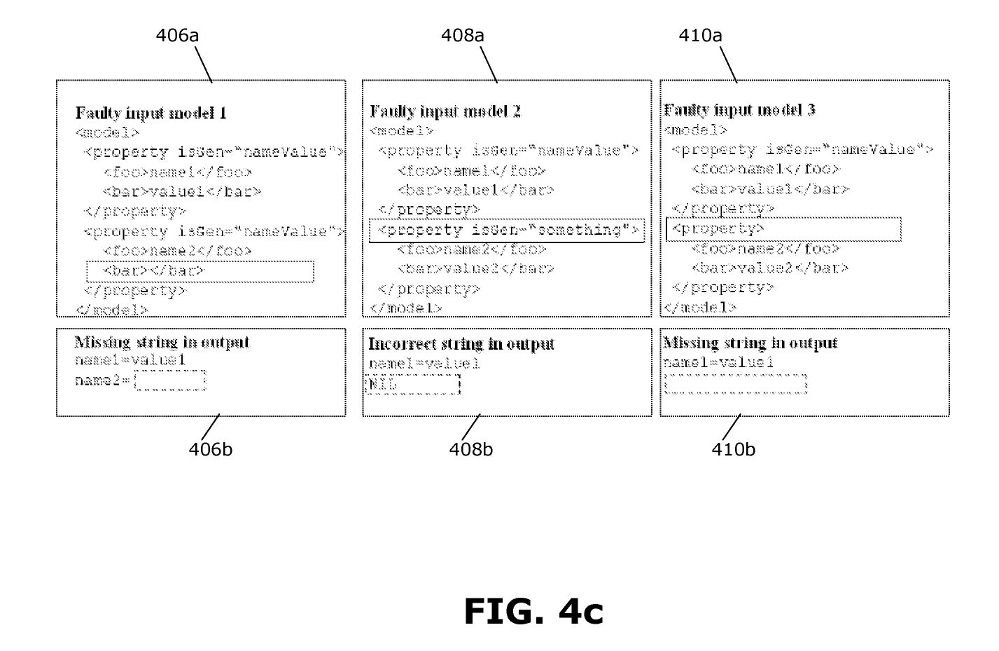

To illustrate these scenarios using a concrete example, FIGS. 4a/b/c elaborate upon the example from FIG. 2. FIG. 4a shows a sample transform 402, written using XSL, that generates name-value pairs from the model. FIG. 4b shows the transformation logic 404 in the form of procedural pseudo-code that could be implemented using a general-purpose programming language. The transform iterates over each property element in the input model and, based on the value of isGen, writes name-value pairs to the output file.

FIG. 4c shows three faulty models 406a/408a/410a and the generated incorrect outputs, 406b/408b/410b, respectively. The solid boxes in 406a/408a/410a highlight the faults, whereas the dashed boxes in 406b/408b/410b highlight the incorrect parts of the output.

In the first faulty model 406a, element bar for the second property is empty. This causes a missing substring in the output 406b, in that the second name-value pair has a missing value. During the execution of the transform of FIG. 4b on the faulty model 406a, in the first iteration of the loop in line 1, the condition in line 2 evaluates true and the string name1=value1 is written to the output 406b. In the second iteration of the loop, the condition evaluates true, but because element bar is empty in the input model 406a, an empty string is written to the output 406b at line 5. Thus, a missing value of an element in the input model 406a causes an empty string to be propagated along a correct path, resulting in a missing substring in the output 406b; this corresponds to path 2→4→5 in FIG. 3.

In the second faulty model 408a, attribute isGen of the second property has an incorrect value, which causes an incorrect path to be taken; in the second iteration of the loop, the ‘else-if’ branch is taken instead of the ‘if’ branch. This results in an incorrect string in the output 408b, with NIL instead of name2=value2. This case corresponds to path 2→3→6 in FIG. 3.

In the third faulty model 410a, the second property is missing attribute isGen. This causes an incorrect path to be taken through the transform; in the second iteration of the loop, both the ‘if’ and the ‘else-if’ branches evaluate false. The resulting output 410b has a missing substring. This case corresponds to path 1→3→5 in FIG. 3.

It can thus be readily appreciated that in a large model that contains thousands of elements and attributes, locating subtle faults as just described can be very difficult. However, in accordance with embodiments of the invention, an approach indeed is configured to guide a user in locating such input-model faults.

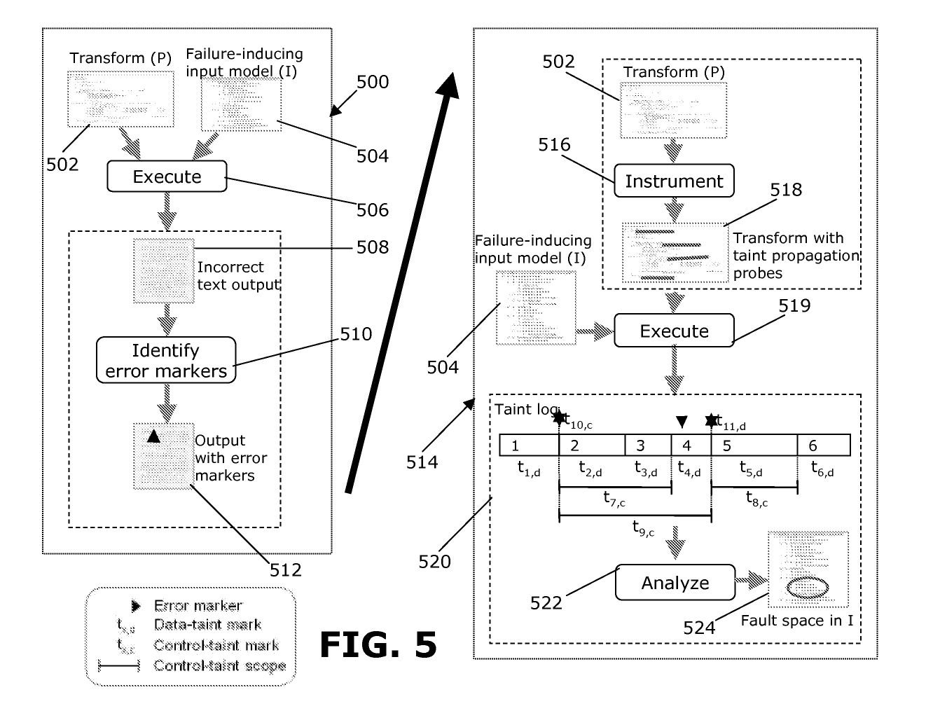

FIG. 5 presents an overview of an approach in accordance with at least one embodiment of the invention. In a first set of steps 500, given a transform program P (502) and a failure-inducing input model I (504), upon execution (506) the approach involves the user identifying (510), in the incorrect text output 508, error markers, which indicate the points in the output string 512 at which a substring is missing or an incorrect substring is generated.

Next, in a second set of steps 514, the approach instruments P (502), at 516, to add probes, whereby the probes associate taint marks with the elements of I and propagate the taint marks to track the flow of data from the elements of I to the output string. The execution (519) of the instrumented transform 518 on I (504) generates a taint log 520, in which taint marks are associated with substrings of the output. Finally, the taint log is analyzed (522) and, using the information about the error markers, the fault space in I is identified (524).

The disclosure now turns to three aspects of an approach in accordance with at least one embodiment of the invention: identification of error markers; association and propagation of taint marks; and analysis of taint logs.

Generally, in accordance with at least one embodiment of the invention, a suitable starting point for failure investigation is a relevant context, which provides information about where the failure occurs. In conventional fault localization, the relevant context is typically a program statement and the data that is observed to be incorrect at that statement. In contrast, the relevant context in an approach according to at least one embodiment of the invention is a location in the output string at which a missing substring or an incorrect substring (i.e., the failure) is observed. For a model-to-text transform, such a relevant context is appropriate because a transform typically builds the output text in a string buffer b that is printed out to a file at the end of the transformation. If the fault localization were to start at the output statement and the string buffer b as a relevant variable, the entire input model would be identified as the fault space.

In an embodiment of the invention, the relevant context for fault localization is an error marker. An error marker is an index into the output string at which a substring is missing or an incorrect substring is generated. In most cases, the user would examine the output text and manually identify the error marker. However, for certain types of output texts, the error-marker identification can be partially automated. For example, if the output is a Java program, compilation errors can be identified automatically using a compiler; these errors can be used to specify the error marker. Similarly, for an XML output, error markers can be identified using a well-formedness checker.

Identification of error markers can be complex. In some cases, a failure may not be observable by examining the output string: the failure may manifest only where the output is used or accessed in certain ways. In other cases, a failure may not be identifiable as a fixed index into the output string. In an approach according to at least one embodiment of the invention, it is assumed that the failure can be observed by examining the output string and that the error marker can be specified as a fixed index.

In accordance with at least one embodiment of the invention, taint marks are associated with the input model. Taint marks can be associated at different levels of granularity of the input-model entities, which involve a cost-accuracy tradeoff. A finer-grained taint association can improve the accuracy of fault localization, but at the higher cost of propagating more taint marks. In an approach according to at least one embodiment of the invention, a unique taint mark is associated with each model entity, from the root element down to each leaf entity in the tree structure of the input model.

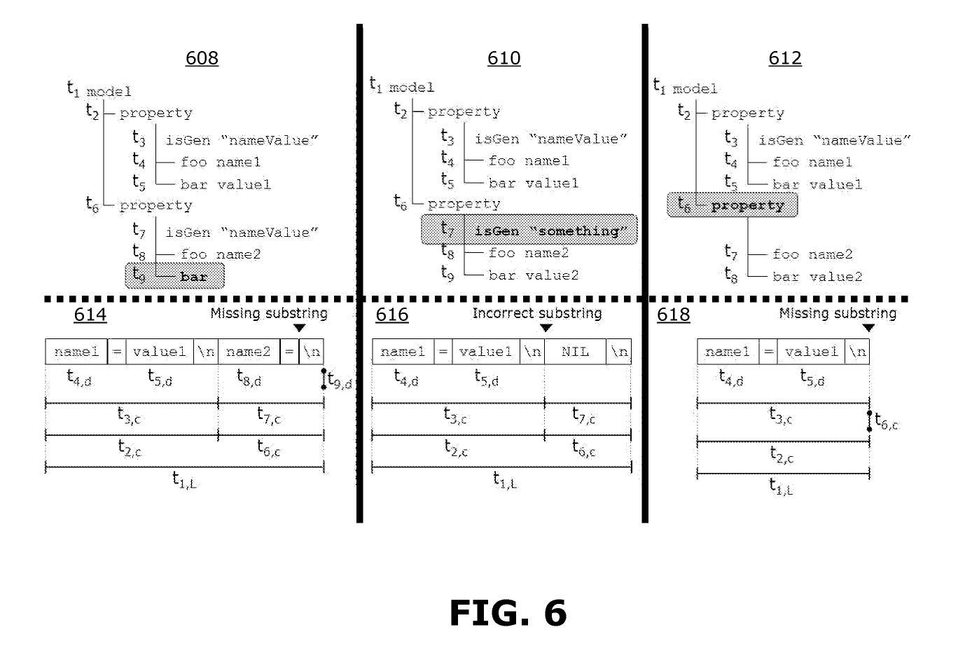

Accordingly, the top part of FIG. 6 illustrates taint associations 608/610/612, respectively for the three faulty input models 408a/410a/412a of FIG. 4c. Each model element and attribute is initialized with a unique taint mark tᵢ. Thus, the first two models have nine taint marks, whereas the third model has eight taint marks because the isGen attribute is missing in that model.

During the execution of the instrumented transform, these taint marks are propagated to the output string through variable assignments, library function calls, and statements that construct the output string.

In accordance with at least one embodiment of the invention, in addition to propagating taint marks at assignment and string-manipulation statements, taint marks are propagated at conditional statements. (For the purposes of discussion herein, in accordance with at least one embodiment of the invention, the term “conditional” may be taken to refer to the different language constructs that provide for conditional execution of statements, such as if statements, looping constructs, and switch statements.) In accordance with embodiments of the invention, such taint marks are classified as control-taint marks, and are distinguished from data-taint marks, which are propagated at non-conditional statements. In addition, taint marks are propagated, in accordance with at least one embodiment of the invention, at looping constructs to scope out, in the output string, the beginning and end of each loop; such taint marks can be referred to as loop-taint marks.

Intuitively, a control-taint mark identifies the input-model elements that affect the outcome of a condition in a failing execution ∈. Such taint marks assist with identifying the faults that cause an incorrect path to be taken through the transform code in ∈. In accordance with at least one embodiment of the invention, at a conditional statement c, the taint marks {t} associated with the variables used at c are propagated to the output string and classified as control-taint marks. In the output string, the taints in {t} identify locations at which an alternative substring would have been generated had c evaluated differently (e.g., “true” instead of “false”) during the execution.

It should be appreciated that a loop taint is a further categorization of control taints; it bounds the scope of a loop. Loop taints are useful for locating faults that cause an incorrect number of iterations of a loop. In cases where an instance of an iterating input-model element is missing and the user of the transform is able only to point vaguely to a range as an error marker, the loop bounds allow the analysis to identify the input-model element that represents the collection with a missing element.

Continuing, FIG. 6 also presents an intuitive illustration of taint logs 614/616/618 that are generated by the execution of the instrumented transforms corresponding to taint associations 608/610/612, respectively (and also corresponding to the three faulty input models 408a/410a/412a of FIG. 4c). In each taint log 614/616/618, substrings (other than string literals) of the output string have taint marks associated with them, and each taint mark is classified as a data taint, a control taint, or a loop taint.

Consider taint log 614 for the first faulty model. Data taint t_{4,d} is associated with substring name1, which indicates that the name1 is constructed from the input-model element that was initialized with taint t₄ (element foo of the first property). A data taint may be associated with an empty substring, as illustrated by t_{9,d}. This indicates that element bar of the second property, which was initialized with t₉, is empty.

In accordance with at least one embodiment of the invention, a control taint has a scope that is bound by a start location and an end location in the output string. The scope of control taint t_{3,c} indicates that name1=value1 was generated under the conditional c at which t₃ was propagated to the output string; and, therefore, that the substring would not have been generated had c evaluated differently. In the corresponding pseudo-code shown in 404 of FIG. 4b, c corresponds to the conditional in line 2. Also, attribute isGen of the first property was initialized with t₃; thus, that attribute determined that name1=value1 was generated. A different value for that attribute could have caused the conditional of line 2 to evaluate differently and, consequently, the generation of an alternative sub-string. A control taint may have an empty scope; in accordance with at least one embodiment of the invention, this occurs when no output string is generated along the “taken branch” from a conditional.

In the taint log 618 for the third faulty model, control taint t_{6,c} has an empty scope. This happens because in the second iteration of the loop in 404 of FIG. 4b, the conditionals 2 and 7 evaluated false, and along the taken branch, no string was generated. Loop-taint mark t_{i,L} scopes out the loop iterations; a control taint is generated for each iteration of the loop.

To summarize, in accordance with at least one embodiment of the invention, data taints are propagated at each assignment statement and each statement that manipulates or constructs the output string. At a conditional statement s that uses model entity e, the data taints associated with e are propagated, as control taints, to bound the output substring generated within the scope of s. Similarly, at a loop header L that uses entity e, the data taints associated with e are propagated, as loop taints, to bound the output string generated within the body of L.

In accordance with at least one embodiment of the invention, control-taints have a scope, defined by a start index and an end index, in the output string. To propagate the start and end control-taints to the output string, an approach in accordance with at least one embodiment of the invention identifies the program points at which conditionals occur and the join points for those conditionals. Accordingly, for each conditional c, the approach propagates the taint marks associated with the variables used at c to the output string, and classifies the taint marks as control-taints. Similarly, it propagates the corresponding end control-taints before the join point of c.

To help further illustrate the computation of control-taint propagation points, some further definitions may be helpful. In accordance with at least one embodiment of the invention, a control-flow graph (CFG) contains nodes that represent statements, and edges that represent potential flow of control among the statements; a CFG has a unique entry node, which has no predecessors, and a unique exit node, which has no successors. A node v in the CFG postdominates a node u if and only if each path from u to the exit node contains v. v is the immediate postdominator of node u if and only if there exists no node w such that w postdominates u and v postdominates w. A node u in the CFG dominates a node v if and only if each path from the entry node to v contains u. An edge (u, v) in the CFG is a back edge if and only if v dominates u. A node v is control dependent on node u if and only if v postdominates a successor of u, but does not postdominate u. A control-dependence graph contains nodes that represent statements and edges that represent control dependences: the graph contains an edge (u, v) if v is control dependent on u. A hammock graph H is a subgraph of CFG G with a unique entry node hₑ∈H and a unique exit node hₓ∉H such that: (1) all edges from (G-H) to H go to hₑ, and (2) all edges from H to (G-H) go to hₓ (for a discussion of this phenomenon see, for example, Ferrante, J., Ottenstein, K. J., Warren, J. D., “The program dependence graph and its use in optimization,” ACM Trans. Progr. Lang. Syst. 9[3], 319-349 [1987]).

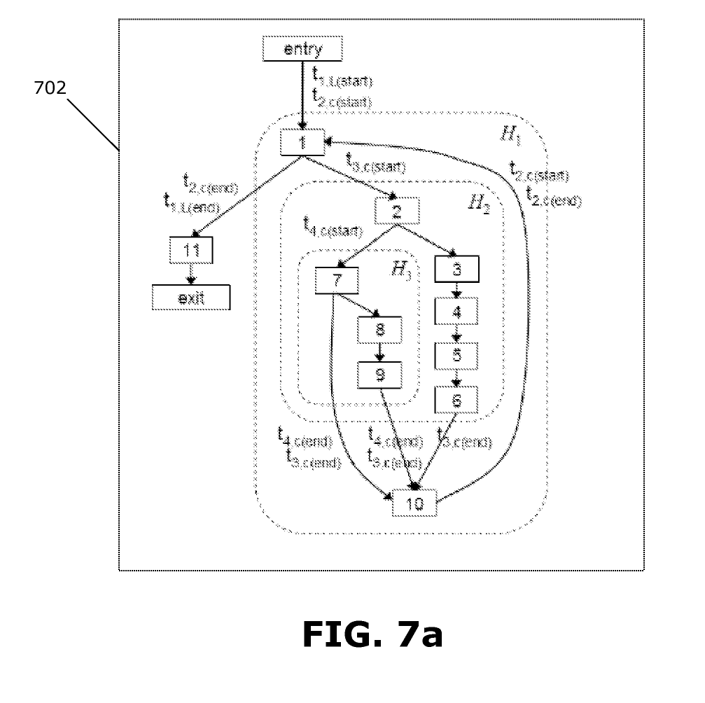

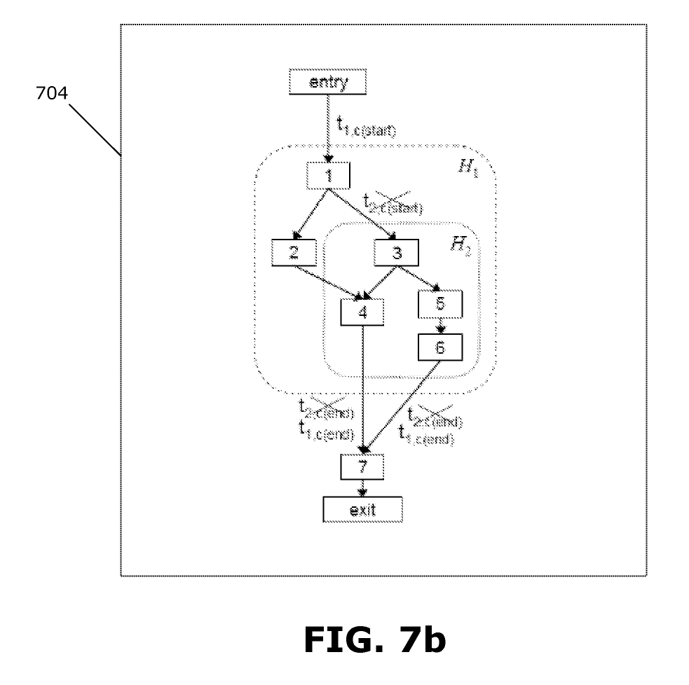

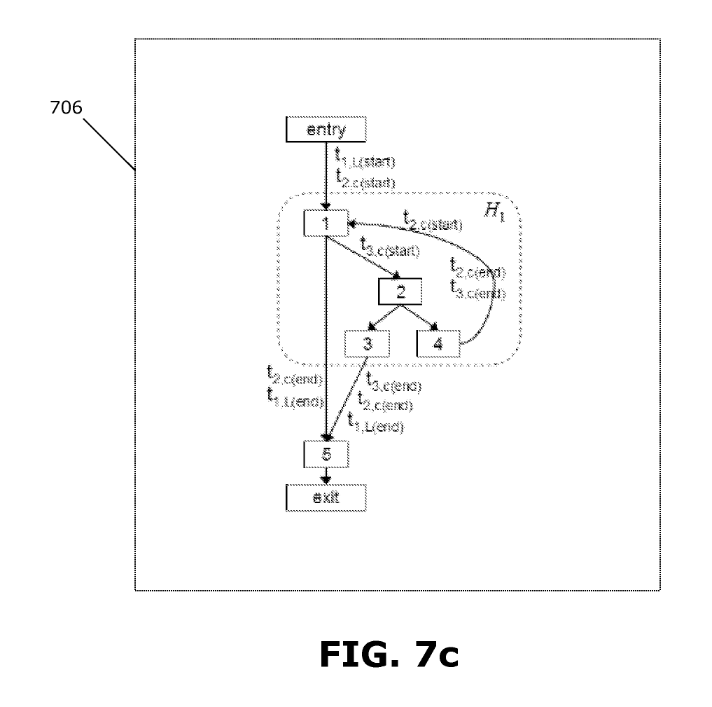

FIGS. 7a/b/c illustrate the identification of control-taint propagation points in accordance with at least one embodiment of the invention. FIG. 7a shows the CFG 702 for the sample transform 402 of FIG. 4a; each hammock in the CFG 702 is highlighted with a dashed bounding box. For if statement 2, a start control-taint, t_{3,c(start)}, is propagated before the execution of the statement. The join point of statement 2 is statement 10, which is the immediate postdominator of statement 2. Therefore, a corresponding end control-taint, t_{3,c(end)}, is propagated before node 10, along each incoming edge. Similarly, start control-taint t_{4,c(start)} is propagated before the nested if statement. The immediate postdominator of this statement is also node 10. However, end control-taint t_{4,c(end)} is propagated along incoming edges (7, 10) and (9, 10) only—and not along incoming edge (6, 10) because the start taint is not reached in the path to node 10 along that edge. If t_{4,c(end)} were to be propagated along edge (6, 10), the path (entry, 1, 2, 3, 4, 5, 6, 10) would have no matching start taint for t_{4,c(end)}.

In accordance with at least one embodiment of the invention, along each path in the CFG 702, the propagation of start and end control-taint marks is properly matched such that each start control-taint has a corresponding end control-taint and each end control-taint is preceded by a corresponding start control-taint. As such, for loop header 1, start loop-taint t_{1,L(start)} and start control-taint t_{2,c(start)} are propagated before the loop header, while corresponding end taints (t_{1,L(end)} and t_{2,c(end)}) are propagated before node 11, the immediate postdominator of node 1. In addition, control taints are also propagated along the back edge, which ensures that each iteration of the loop generates a new control-taint scope.

FIG. 7b illustrates a CFG 704 with a nonstructured if statement; the nested if statement is nonstructured because its else block has an incoming jump from outside the block (through edge (2, 4)). For such if statements, start and end taint propagation can result in the taints not being properly matched along some path in the CFG 704. If t_{2,c(start)} and t_{2,c(end)} were propagated as shown in FIG. 7b, path (entry, 2, 4, 7) contains an unmatched end taint: t_{2,c(end)}. To avoid such cases and ensure that control-taints are properly matched along all paths, an approach in accordance with at least one embodiment of the invention performs taint propagation for only those conditionals that form a hammock graph. A hammock graph H has the property that no path enters H at a node other than hₑ and no path exits H at a node other than hₓ. Therefore, propagating a start control-taint before hₑ and an end control-taint before after each predecessor of hₓ guarantees that the control taints are properly matched through H. In the CFG 704 shown in FIG. 7b, because the nested if statement does not form a hammock, no control-taint propagation is performed (shown as the crossed-out control-taints).

FIG. 7c shows a CFG 706 that includes a loop with a break statement, wherein node 3 represents a break statement that transfers control outside the loop. In this case, as illustrated, in accordance with at least one embodiment of the invention, end control-taints need to be propagated along the edge that breaks out of the loop. Moreover, conditional statements within the loop that directly or indirectly control a break statement do not induce hammocks: e.g., if statement 2 does not form a hammock. For such statements, control taints need to be propagated appropriately, as illustrated in FIG. 7c.

Similar to nonstructured if statements, a loop may be nonreducible, in that control may jump into the body of the loop from outside of the loop without going through the loop header. In accordance with at least one embodiment of the invention, an analysis performs no control-taint propagation for such loops because matched control-taints cannot be created along all paths through the loop.

In accordance with at least one embodiment of the invention, the execution of the instrumented transform generates a taint log, in which substrings of the output string have taint marks associated with them. Accordingly, a third step of an approach in accordance with at least one embodiment of the invention serves to analyze the taint log to identify the fault space in the input model. Overall, the log analysis performs a backward traversal of the annotated output string, and iteratively expands the fault space, until the fault is located. To start the analysis, the user specifies an error marker and whether the error is an incorrect substring or a missing substring.

As discussed further above, the bottom part of FIG. 6 shows taint logs 614/616/618 corresponding to the three failure-inducing models 408a/410a/412a of the sample transform from FIG. 4c. The taint logs include error markers, and computed fault spaces. The first and the third faulty models (408a/412a of FIG. 4c) cause missing strings in the output (as appreciated in accordance with taint logs 614/618), whereas the second faulty model (410a of FIG. 4b) causes an incorrect substring in the output (as appreciated in accordance with taint log 616).

A failing transformation that results in a missing substring could be caused by the incorrect empty value of an element or attribute. The first faulty model represented in FIG. 6 (608/614) illustrates this. Alternatively, a missing substring could be caused by a wrong path through the transformation: i.e., a conditional along the traversed path could have evaluated incorrectly, which caused the substring to not be generated along the taken-path. The third faulty model represented in FIG. 6 (612/618) illustrates this.

To compute the fault space for missing substrings, in accordance with at least one embodiment of the invention, the log analysis identifies empty data taints and empty control taints, if any, that occur at the error marker, and forms the first approximation of the fault space, which includes the input-model entities that were initialized with these taints. If the initial fault space does not contain the fault, the analysis identifies the enclosing control taints, starting with the innermost scope and proceeding outward, to expand the initial fault space iteratively, until the fault is located.

For the first faulty model represented in FIG. 6 (608/614), the analysis identifies empty data taint t_{9,d} and sets the initial fault space to contain element bar of the second property. Because the fault space contains the fault, the analysis terminates. Similarly, for the third faulty model represented in FIG. 6 (612/618), the analysis identifies empty control taint t_{6,c} and sets the initial fault space to the second property element, which contains the fault. Thus, in both cases, the analysis precisely identifies the fault in the first approximation of the fault space.

On the other hand, an incorrect substring could be generated from the incorrect value of an input-model entity; alternatively, the incorrect string could be generated along a wrong path traversed through the transform. To compute the fault space for incorrect substrings, the log analysis in accordance with at least one embodiment of the invention identifies the data taint associated with the substring at the error marker. For the second faulty model represented in FIG. 6 (610/616), the analysis looks for data taints. Because no data taints are associated with the output string at the error marker, the analysis considers the enclosing control taint, t_{7,c}, and adds the input-model element initialized with t₇ to the fault space. This fault space contains the second property element; thus, the analysis identifies the fault.

To summarize, for a missing substring, the log analysis in accordance with at least one embodiment of the invention starts at an empty data taint or an empty control taint, and computes the initial fault space. For an incorrect substring, the analysis starts at a non-empty data taint to compute the initial fault space. Next, for either case, the analysis traverses backward to identify enclosing control taints—in reverse order of scope nesting—and incrementally expands the fault space. The successive inclusion of control taints lets the user investigate whether a fault causes an incorrect branch to be taken at a conditional, which results in an incorrect string or a missing string at the error marker.

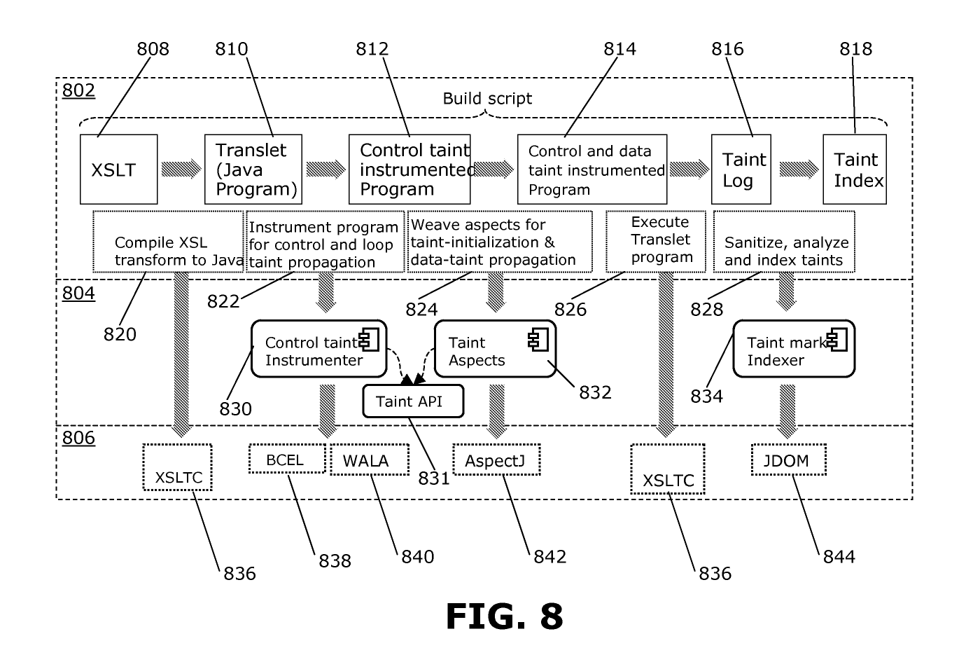

FIG. 8 schematically illustrates the architecture and flow of a sample implementation of an approach, in accordance with at least one embodiment of the invention, for XSL-based transforms The top part of FIG. 8 (802) shows the process steps and the artifacts that are generated or transformed by each step, while the middle part of FIG. 8 (804) shows components utilized in the implementation.

In the implementation of FIG. 8, the components 804 include: a taint API 831 that contains taint-initialization and taint-propagation methods; an instrumentation component 830 that adds probes (822) to invoke control-tainting and loop-tainting methods; an aspect-weaver component 832 that weaves in (824) aspects to the instrumented bytecode to invoke taint initialization and data-tainting methods; and an indexer component 834 that sanitizes and indexes (828) the raw taint log to make it appropriate for querying.

The bottom part of FIG. 8 shows external software employed in the implementation in out-of-the-box manner.

It should be noted that in the implementation of FIG. 8 the addition of probes that invoke tainting methods is split into two steps. In the first step, bytecode instrumentation is used (822) to add calls to control- and loop-tainting methods. In the second step, aspects to add calls to data-tainting methods are used (824).

In the contemplated implementation of FIG. 8, for XSL-based transforms, data propagation occurs through calls to the Xalan library. Aspects provide an easy way to add instrumentation code around method calls, thereby removing the need to instrument the actual library code. (Generally, an aspect is a modular unit designed to implement a concern. An aspect definition may contain some code or advice and the instructions on where, when, and how to invoke the aspect Depending on the aspect language, aspects can be constructed hierarchically, and the language may provide a separate mechanism for defining an aspect and specifying its interaction with an underlying system.) Therefore, in the sample implementation of FIG. 8, aspects for data-taint propagation are employed. However, AspectJ does not provide any join-points for conditionals; therefore, the sample implementation of FIG. 8 performs direct bytecode instrumentation to propagate control and loop taints.

In a first step of the process encompassed by the sample implementation of FIG. 8, because here the analysis infrastructure is Java-based, the XSL transform 808 is first compiled into Java bytecode (820). In the sample implementation of FIG. 8, an Apache XSL transform compiler (XSLTC) (see, for example, http://xml.apache.org/xalan-j/xsltc), indicated at 836, is used for this purpose. The xsltc compiler 836 generates an equivalent bytecode program (called translet) for the XSL. This transform program can be executed using the xsltc runtime API.

Next, in the process encompassed by the sample implementation of FIG. 8, the instrumentation component 830 adds probes (822) to the translet bytecode 810 to propagate control and loop taints. The component 830 here includes a taint-location analyzer and a bytecode instrumenter. The taint-location analyzer is developed in this embodiment of the invention using the wala analysis infrastructure (see, for example, http://wala.sourceforge.net), indicated 840. This uses wala to perform control-flow analysis and dominance/postdominance analysis. Using these, it identifies loops and loop-back edges and, for each conditional c, checks whether c is the entry node of a hammock graph. (Because the analysis is performed on bytecode, which encode loops using if and goto instructions, loop detection here, in the sample implementation of FIG. 8, is based on the identification of back-edges.) The analyzer identifies all taint-propagation locations according to the related algorithm discussed hereinabove. Each taint location is specified using a bytecode offset and information about what instrumentation action to perform at that offset.

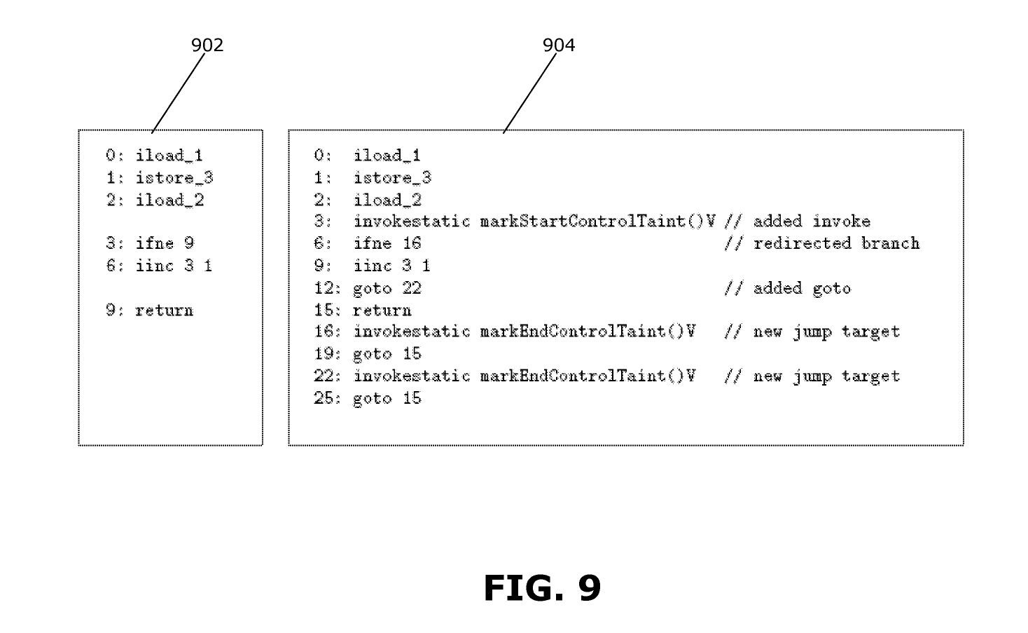

In the sample implementation of FIG. 8, the instrumenter processes the taint locations, and uses bcel (see, for example, http:/jakarta.apache.org/bcel), indicated at 838, to add byte-code instructions and modify existing instructions. The instrumenter 830 performs three types of actions: (1) add calls to the tainting methods; (2) redirect existing branch and goto instructions, and (3) add new goto instructions. In the context of the sample implementation of FIG. 8, FIG. 9 shows code fragments 902/904 which illustrate these actions.

In FIG. 9, the fragment 902 shows the original bytecode (P) that encodes an if-then statement; the fragment 904 shows the instrumented bytecode (P′), in which calls to tainting methods (from the taint API) have been added. In P′, at offset 3, a call to tainting method markStartControlTaint( ) has been added. In P, the if statement at offset 3 transfers control to offset 9, which is the end of the if-then block. In P′, the branch has been redirected to first invoke (at offset 16) the end control-taint method markEndControlTaint( ), and then jump to the original target (offset 9 in P, offset 15 in P′) of the branch. At the end of the then branch (offset 6 in P, offset 9 in P′), a goto instruction has been added to ensure that the end control-taint method is called before control flows out of the then block.

Returning now to FIG. 8, an aspect-weaver component 832 of the sample implementation defines abstract aspects for taint initialization and data-taint propagation. In the sample implementation of FIG. 8, these abstract aspects are implemented by providing a set of specific point-cut definitions and corresponding advices. The advices invoke tainting methods from the taint API 831. The taint-initialization aspect 812, woven to the XML parser, assigns a unique taint mark to each element, and for each element, to each of its attributes and content. The point-cuts and advices of the data-taint-propagation aspect 814, are implemented based on an understanding of the general profile of transform programs generated by the xsltc compiler.

Next, in the sample implementation of FIG. 8, the process executes the fully instrumented translet (instrumented for taint initialization, data-taint propagation, and control-taint propagation) (826) on the faulty input. Here, the xsltc command-line API is used (from 836). The execution of the instrumented translet produces an annotated taint log 816. For a data-taint tag, the taint information contains either a taint mark, or an association to an intermediate variable created and used in the XSL transform. The taint information for a variable tag may itself contain either taint marks, or associations to other intermediate variables. A control-taint tag may contain a taint mark or an association to an intermediate variable, and/or the conditions. The condition tag may contain a taint mark or variable associations for both the left-hand and right-hand expressions of the conditional statement, along with the conditional operand. For loop constructs, the annotations contain just the loop tag.

Finally, in the sample implementation of FIG. 8, the indexer component 834 sanitizes, analyzes, and indexes the taint-marks associations with the output substrings. Here, it performs two steps now to be discussed.

First, the taint log 816 is sanitized (828) in order to process it as an XML document. However, the actual output of the transform may either itself be an XML (leading to a possible interleaving of its tags with tags of the process according to FIG. 8) or it may contain special characters (e.g., the greater-than comparison operator in an output Java program). Either of these cases can make the taint log an invalid XML To avoid this, in the sample implementation of FIG. 8, the taint log 816 is sanitized by encapsulating all the actual output chunks between tags as CDATA sections. (In XML, a CDATA section is a section of element content that is marked for the parser to interpret as only character data, not markup.)

Secondly, in the sample implementation of FIG. 8, the indexer analyzes and indexes the sanitized taint log to result in a taint index 818. It uses JDOM (see, for example, http://www.jdom.org) (844) and XML processing to traverse the sanitized taint log as an XML document. It processes the special CDATA sections, created during the sanitizing pass, sequentially in the order of their occurrence. It associates the parent taint element tags with the ranges of the output segments bounded within the CDATA sections. For the CDATA ranges associated with intermediate variables, the indexer 834 keeps a temporary mapping of variables with taint marks, which it uses for resolving tainted ranges associated with the use of those variables. Further, based on the containment hierarchy of taint tags, a list of taint marks representing an iterative expansion of the fault space is indexed for relevant ranges in the output. Finally, the indexer provides an API on the taint index 818 that supports queries for taint marks (or probable taint marks) associated with a position (or a range) in the output, with additional information about whether the output is missing or incorrect.

In accordance with the sample implementation of FIG. 8, a suitable build script such as an Apache Ant build script, which takes the XSL transform program and the input model as inputs, completely automates the entire process and enables a one-click execution of the process. Of course, it should be understood that this and other elements of the sample implementation of FIG. 8, as presented and discussed herein, may be interchanged with other substantially equivalently functioning elements that may be deemed suitable for the context at hand.

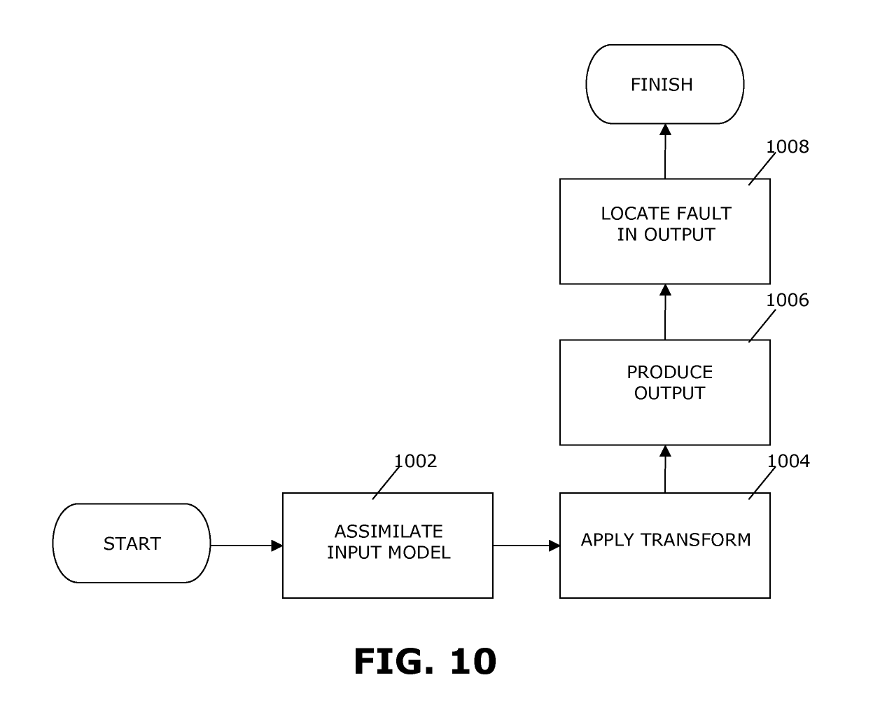

FIG. 10 sets forth a process more generally for ascertaining faults in an output model based on taint marks associated with an input model, in accordance with at least one embodiment of the present invention. It should be appreciated that a process such as that broadly illustrated in FIG. 10 can be carried out on essentially any suitable computer system or set of computer systems, which may, by way of an illustrative and on-restrictive example, include a system such as that indicated at 100 in FIG. 1. In accordance with an example embodiment, most if not all of the process steps discussed with respect to FIG. 10 can be performed by way of system processors and system memory such as those indicated, respectively, at 42 and 46 in FIG. 1.

As shown in FIG. 10, an input model is assimilated (1002) and a transform is applied to the input model (1004). The process then produces an output from the transform (1006) and locates a fault in the input model based on an error location specified in the output (1008).

In brief recapitulation, there is broadly contemplated herein, in accordance with embodiments of the invention, an approach for assisting transform users with debugging their input models. Unlike conventional fault-localization techniques, such an approach focuses on the identification of input-model faults, which, from the perspective of transform users, is the relevant debugging task. Such an approach uses dynamic tainting to track information flow from input models to the output text. The taints associated with the output text guide the user in incrementally exploring the fault space to locate the fault. A novel feature of such an approach is that it distinguishes between different types of taint marks (data, control, and loop), which enables it to identify effectively the faults that cause the traversal of incorrect paths and incorrect number of loop iterations. It has been found that such an approach can be very effective in reducing the fault space substantially.

While implementations discussed and broadly contemplated herein serve to analyze XSL-based transforms, it should be noted that extensions to accommodate other types of model-to-text transforms, such as JET-based transforms, and even general-purpose programs (for which a goal of debugging might be to locate faults in inputs), are certainly conceivable.

While debugging approaches as broadly contemplated and discussed herein focus on fault localization, a conceivable variant would involve the support of fault repair. Such a variant technique could recommend fixes by performing pattern analysis on taint logs collected for model elements that generate correct substrings in the output text. Another possible variant technique, applicable for missing substrings, could involve forcing the execution of not-taken branches in the transform to show to the user potential alternative strings that would have been generated had those paths been traversed.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. A method comprising:
assimilating and instrumenting an input model;
instrumenting a model to text transform;
applying the instrumented transform to the instrumented input model;
producing an output from the instrumented transform; and
locating a fault in the input model based on an error location specified in the output.

2. The method according to claim 1, wherein said step of instrumenting the input model comprises associating a taint-mark to entities in the input model.

3. The method according to claim 2, wherein:
said step of instrumenting the transform comprises modifying the transform to propagate the taint-marks over data-flow, control-flow and loop constructs;
said step of applying the instrumented transform comprising generating a tainted output;
said step of locating the fault in the input model comprising querying the tainted output for a specified error location in the output, to ascertain the portion of the input model which contributes to the error.

4. The method according to claim 1, wherein:
said step of applying the instrumented transform comprises imparting a first taint mark to the input model; and
said step of producing an output comprises imparting a second taint mark to a portion of the output model, the second taint mark being related to the first taint mark and comprising information to ascertain a portion of the input model which contributes to a fault associated with the output model.

5. The method according to claim 4, wherein said imparting a second taint mark comprises imparting a second taint mark which comprises information to ascertain a portion of the input model which contributes to a fault in the output model.

6. The method according to claim 4, wherein said imparting a second taint mark comprises imparting a second taint mark which comprises information to ascertain a portion of the input model which causes an incorrect path to be executed in said step of applying a transform.

7. The method according to claim 4, wherein said imparting a second taint mark comprises imparting a second taint mark which comprises information to ascertain a portion of the input model which contributes to an incorrect string in the output model.

8. The method according to claim 4, wherein said imparting a second taint mark comprises imparting a second taint mark which comprises information to ascertain a portion of the input model which contributes to a missing string in the output model.

9. The method according to claim 4, further comprising iteratively expanding a search space for ascertaining a fault in the input model.

10. The method according to claim 4, wherein:
said producing an output comprises tracing propagation of the first taint mark through a statement in the transform; and
said tracing comprises tracing propagation of the first taint mark through a statement taken from the group consisting essentially of: a conditional statement; a loop statement; a data-flow statement.

11. The method according to claim 4, wherein said imparting a second taint mark comprises imparting a taint mark taken from the group consisting essentially of: a visual taint-tag; taint metadata.

12. The method according to claim 4, further comprising:
reading the output model and building an index of taint marks;
said building an index comprising correlating a text range in the output model to a taint mark.

13. An apparatus comprising:
one or more processors; and
a computer readable storage medium having computer readable program code embodied therewith and executable by the one or more processors, the computer readable program code comprising:
computer readable program code configured to assimilate and instrument an input model;
computer readable program code configured to instrument a model to text transform;
computer readable program code configured to apply the instrumented transform to the instrumented input model;
computer readable program code configured to produce an output from the instrumented transform; and
computer readable program code configured to locate a fault in the input model based on an error location specified in the output.

14. A computer program product comprising:
a computer readable storage medium having computer readable program code embodied therewith, the computer readable program code comprising:
computer readable program code configured to assimilate and instrument an input model;
computer readable program code configured to instrument a model to text transform;
computer readable program code configured to apply the instrumented transform to the instrumented input model;
computer readable program code configured to produce an output from the instrumented transform; and
computer readable program code configured to locate a fault in the input model based on an error location specified in the output.

15. The computer program product according to claim 14, wherein said computer readable program code is configured to associate a taint-mark to entities in the input model.

16. The computer program product according to claim 15, wherein:
said computer readable program code is configured to modify the transform to propagate the taint-marks over data-flow, control-flow and loop constructs;
said computer readable program code is configured to generate a tainted output; and
said computer readable program code is configured to query the tainted output for a specified error location in the output, to ascertain the portion of the input model which contributes to the error.

17. The computer program product according to claim 14, wherein:
said computer readable program code is configured to impart a first taint mark to the input model; and
said computer readable program code is configured to impart a second taint mark to a portion of the output model, the second taint mark being related to the first taint mark and comprising information to ascertain a portion of the input model which contributes to a fault associated with the output model.

18. The computer program product according to claim 17, wherein said computer readable program code is configured to impart a second taint mark which comprises information to ascertain a portion of the input model which contributes to a fault in the output model.

19. The computer program product according to claim 17, wherein said computer readable program code is configured to impart a second taint mark which comprises information to ascertain a portion of the input model which causes an incorrect path to be executed in said step of applying a transform.

20. The computer program product according to claim 17, wherein said computer readable program code is configured to impart a second taint mark which comprises information to ascertain a portion of the input model which contributes to an incorrect string in the output model.

21. The computer program product according to claim 17, wherein said computer readable program code is configured to impart a second taint mark which comprises information to ascertain a portion of the input model which contributes to a missing string in the output model.

22. The computer program product according to claim 17, wherein said computer readable program code is configured to iteratively expand a search space for ascertaining a fault in the input model.

23. The computer program product according to claim 17, wherein:
said computer readable program code is configured to trace propagation of the first taint mark through a statement in the transform; and
said computer readable program code is configured to trace propagation of the first taint mark through a statement taken from the group consisting essentially of: a conditional statement; a loop statement; a data-flow statement.

24. The computer program product according to claim 17, wherein said computer readable program code is configured to impart a taint mark taken from the group consisting essentially of: a visual taint-tag; taint metadata.

25. The computer program product according to claim 17, wherein:
said computer readable program code is further configured to read the output model and build an index of taint marks; and
said computer readable program code is configured to correlate a text range in the output model to a taint mark.
